(19) United States
(12) Patent Application Publication
(10) Pub. No.: US 2026/0301287 A1
(43) Pub. Date: Oct. 1, 2026

(54) MULTI-SUBJECT PERSONALIZATION IN VIDEO GENERATION

(71) Applicant: Snap Inc., Santa Monica, CA (US)

(72) Inventors: Kfir Aberman, Redwood City, CA (US); Tsai-Shien Chen, Seattle, WA (US); Willi Menapace, Los Angeles, CA (US); Aliaksandr Siarohin, Santa Monica, CA (US); Ivan Skorokhodov, Santa Monica, CA (US); Junyan Zhu, Pittsburgh, PA (US)

(21) Appl. No.: 19/094,612

(22) Filed: Mar. 28, 2025

(51) Int. Cl. G06T 13/40; G06T 3/40; G06T 3/60; G06T 5/50; G06T 5/70; G06T 5/77; G06T 7/20; G06V 10/74; G06V 10/75; G06V 10/774; G06V 10/776; G06V 40/16

(52) U.S. Cl. CPC G06T 13/40; G06T 3/40; G06T 3/60; G06T 5/50; G06T 5/70; G06T 5/77; G06T 7/20; G06V 10/759; G06V 10/761; G06V 10/774; G06V 10/776; G06V 40/161; G06T 2207/10016; G06T 2207/20081; G06T 2207/20132

(57) ABSTRACT

Examples relate to systems and methods for generating a video depicting multiple subjects. The systems and methods receive a text prompt describing a video to be generated, a plurality of reference images each depicting a corresponding subject, and binding information that associates each reference image with a corresponding entity word in the text prompt. The systems and methods extract features from each reference image and fuse the extracted features with text embeddings of the corresponding entity word based on the binding information to create personalization embeddings. The systems and methods generate an initial noisy video and iteratively de-noise the noisy video using a diffusion model conditioned on both the text prompt and the personalization embeddings to generate a personalized video that preserves identity of the corresponding subjects in the reference images while allowing for natural motion and pose variations.

### TECHNICAL FIELD

The present disclosure relates to computer graphics technologies, specifically to generative rendering engines for generating videos on user devices.

### BACKGROUND

Some electronics-enabled devices, such as computers and mobile devices, allow users to generate personalized video content based on text prompts and reference images. Current approaches to video generation have evolved significantly with the advent of diffusion models, which have demonstrated impressive capabilities in generating realistic videos from text descriptions. These models typically operate by learning to denoise randomly generated noise into coherent visual content guided by textual descriptions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a diagram of a video generation system, according to some examples.

FIG. 6 illustrates a diagram of a training data generation system, according to some examples.

FIG. 7 is a flowchart illustrating a routine (e.g., a method or process), according to some examples.

FIG. 8 illustrates example inputs and outputs of the video generation system, according to some examples.

FIG. 9 illustrates a system including the head-wearable apparatus, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

Conventional approaches to video generation have evolved significantly with the advent of diffusion models, which have demonstrated impressive capabilities in generating realistic images and videos from text prompts. These models typically operate by learning to denoise randomly generated noise into coherent visual content guided by textual descriptions. Early diffusion video models like Imagen Video, Make-A-Video, and VideoLDM are built upon pretrained image generators using cascaded temporal and spatial upsamplers or by fine-tuning latent image generators to produce temporally coherent videos. More recent approaches have moved beyond the traditional U-Net architecture to adopt transformer-based designs. These models have shown significant progress in generating realistic videos with natural motions directly from text descriptions.

However, these conventional text-to-video generation approaches are fundamentally limited by what can be described in words. Text prompts alone cannot effectively capture specific visual concepts like particular individuals, pets, or places (e.g., subjects) with their unique visual characteristics. This limitation has led to the development of personalization techniques that aim to incorporate reference images alongside text prompts, but these methods often struggle with multiple subjects or backgrounds simultaneously. Furthermore, conventional approaches to video personalization typically focus on limited domains, such as face personalization or single subjects from specific categories, while neglecting background personalization. Many methods require time-consuming test-time optimization for each new concept, making them impractical for applications requiring quick turnaround times or handling multiple subjects simultaneously. These inefficiencies, coupled with issues like the “copy-and-paste effect” where models directly replicate reference images without natural motion variations, highlight the need for more comprehensive and efficient video personalization approaches. The inability to effectively disentangle subject identity from contextual factors like lighting conditions, pose, and camera viewpoint represents a limitation in conventional video personalization approaches, resulting in wasted computational resources and suboptimal user experiences.

The disclosed examples improve the efficiency of using the electronic device by providing a system that enables multi-subject open-set personalization in video generation without requiring time-consuming test-time optimization. The system binds reference images with corresponding entity words in text prompts, allowing users to explicitly specify which image represents which subject in the generated video, which can prevent misalignment issues where models might incorrectly apply image conditioning to the wrong subject (such as placing a human face on a dog). Additionally, the disclosed system incorporates data augmentation techniques to prevent overfitting to unintended properties of reference images, enabling the generation of videos with natural motion and pose variations rather than simply copying and pasting the reference images. By processing personalization embeddings through separate cross-attention layers from text embeddings, the disclosed system achieves better balance between text alignment and image fidelity, resulting in more realistic and personalized video outputs while using computational resources more efficiently.

For example, the diffusion model in the disclosed system can be trained through a supervised learning approach using a comprehensive dataset of videos and their corresponding captions. The training process begins with collecting video-caption pairs and processing them to create training data. Entity words (subjects, objects, and/or backgrounds) are retrieved from captions using a large language model (LLM). Multiple frames are selected from each video, and localization algorithms segment (e.g., extract or crop) subjects and objects from these frames. Clean background images are created by removing segmented subjects and applying inpainting algorithms. The diffusion model can be trained in two stages. In the first stage, the diffusion model is trained with only text conditioning. In the second stage, an additional cross-attention layer for personalization conditioning is introduced, and the whole model is fine-tuned with warmup. During training, the diffusion model learns to denoise videos by starting with a purely noisy video, iteratively denoising it using both text and image conditioning, computing the deviation between the generated video and ground truth video, and updating model parameters based on this deviation.

To prevent overfitting, data augmentation techniques are applied to reference images extracted from training videos, including downscaling, Gaussian blurring, color jittering, brightness adjustment, horizontal flipping, image shearing, and rotation. These techniques help the diffusion model focus on subject identity rather than unintended properties like lighting or pose. In some cases, a binding mechanism is used to associate reference images with corresponding entity words in text prompts. After extracting features from reference images, the system fuses these features with text embeddings of the corresponding entity words. This binding is implemented by retrieving word tokens from text embeddings, replicating and concatenating the word tokens with image tokens, passing them through a linear projection module, and adding a learnable image index embedding to separate tokens from different images.

The system can be evaluated using a comprehensive benchmark which supports various conditioning scenarios including face crops, single or multiple subjects, and both foreground and background conditioning. The evaluation metrics include text similarity (measuring alignment between generated content and text prompt), video similarity (comparing generated frames with ground truth), subject similarity (evaluating fidelity of generated subjects compared to reference images), face similarity (assessing preservation of facial features), and dynamic degree (measuring natural motion in generated videos). For multi-subject evaluation, the system segments subjects from both generated (e.g., simulated or artificially synthesized videos) and ground truth videos, then computes similarity metrics for each subject separately, providing a more accurate assessment than whole-image comparison methods.

In some examples, the disclosed examples receive a text prompt describing a video to be generated, a plurality of reference images each depicting a corresponding subject, and binding information that associates each reference image with a corresponding entity word in the text prompt. The disclosed examples extract features from each reference image and fuse the extracted features with text embeddings of the corresponding entity word based on the binding information to create personalization embeddings. The disclosed examples generate an initial noisy video and iteratively de-noise the noisy video using a diffusion model conditioned on both the text prompt and the personalization embeddings to generate a personalized video that preserves the identities of the corresponding subjects in the reference images while allowing for natural motion and pose variations.

### Networked Computing Environment

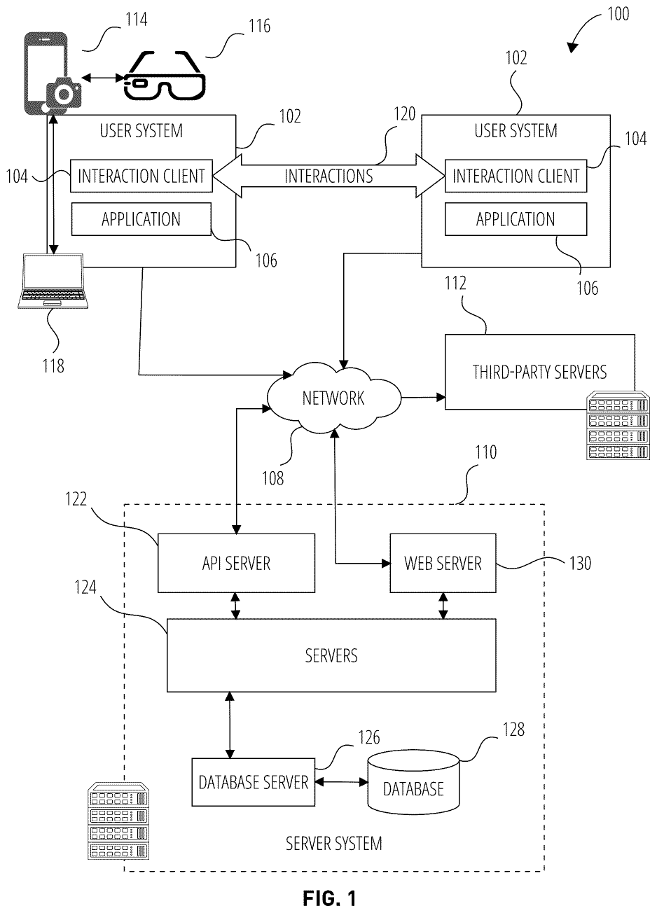

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102, a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to, and provides programmatic interfaces to, servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

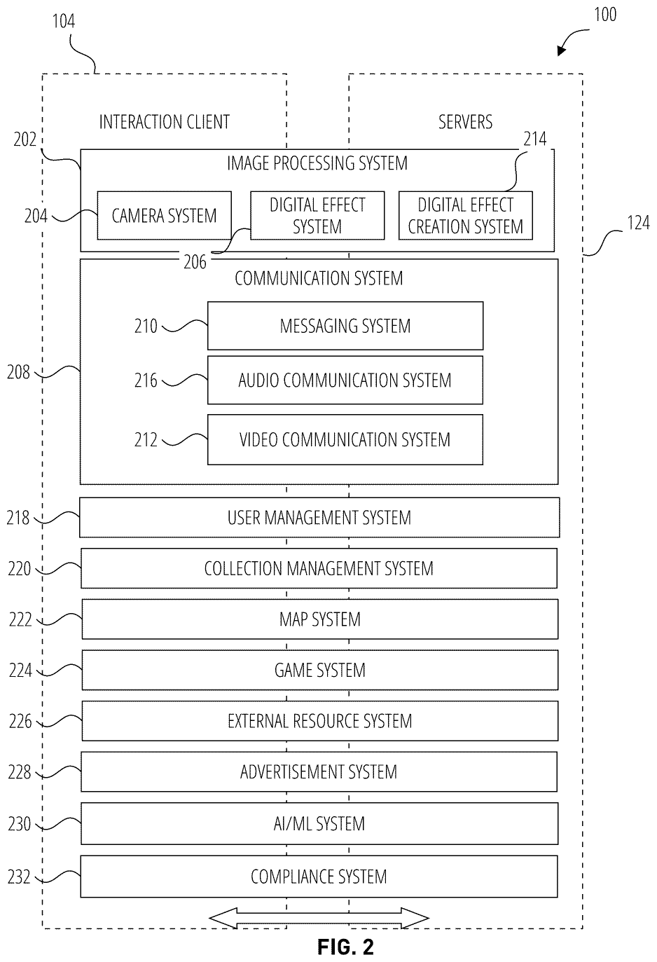

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116. In some examples, the external resources include instructions that define functionality to implement respective digital effects experiences. These instructions can include textual prompts that are processed by local or remote implementations of generative machine learning models to generate the digital effects experiences, such as by presenting artificially generated or artificially augmented video with one or more digital effects.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture.

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

A digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 902 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model. In some cases, the prompts can instruct the generative machine learning model (GenAI) to process an image or video of an avatar along with audio input and to generate a video that depicts the avatar (lips of the avatar) speaking speech provided by the audio input.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports AR developer platforms and includes an application for content creators (e.g., artists and developers) to create and publish digital effects (e.g., AR experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308, and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a graphical user interface (GUI) of the interaction client 104 to access features of the web-based external resource, the interaction client 104 obtains the HTML5 file and instantiates the resources to access the features of the web-based external resource.

The interaction client 104 presents a GUI (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up a menu (e.g., animates a menu as surfacing from a bottom of the screen to a middle or other portion of the screen) for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end users via the interaction clients 104 and handles the delivery and presentation of these advertisements.

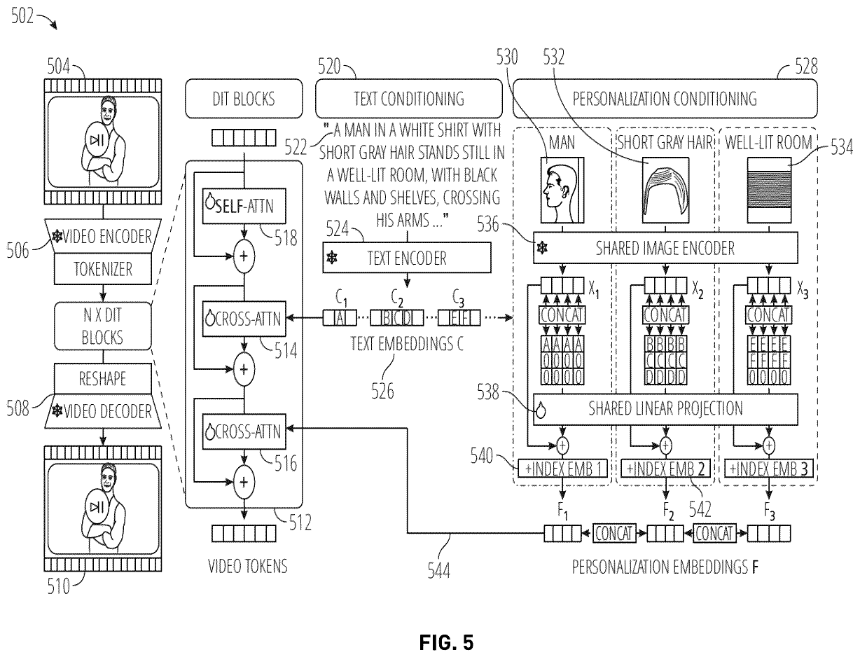

An artificial intelligence and machine learning system 230 provides a variety of services to different subsystems within the digital interaction system 100 including a video generation system 502 (FIG. 5).

For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions.

For example, the artificial intelligence and machine learning system 230 (e.g., using the video generation system 502) provides comprehensive support for multi-subject personalization in video generation through integration with various subsystems of the digital interaction system. The artificial intelligence and machine learning system 230 operates with the image processing system 202 and camera system 204 to analyze images captured by user devices, extracting critical information such as objects, subjects, and backgrounds. This extracted information enables the system to identify and segment specific entities within images that can later be used as reference images for personalization.

When working with the digital effect system 206, the artificial intelligence and machine learning system 230 processes personalization embeddings through dedicated cross-attention layers that are separate from text embeddings. This architectural design allows the system to achieve better balance between text alignment and image fidelity, resulting in more realistic personalized video outputs. The system binds reference images with corresponding entity words in text prompts, allowing users to explicitly specify which image represents which subject in the generated video, thereby preventing misalignment issues where models might incorrectly apply image conditioning to the wrong subject.

For video generation tasks, the artificial intelligence and machine learning system 230 implements a diffusion model that iteratively de-noises videos by starting with purely noisy video frames and gradually refining them using both text and image conditioning. The artificial intelligence and machine learning system 230 applies sophisticated data augmentation techniques to reference images, including downscaling, Gaussian blurring, color jittering, brightness adjustment, horizontal flipping, image shearing, and rotation. These techniques help prevent overfitting to unintended properties of reference images, enabling the generation of videos with natural motion and pose variations rather than simply copying and pasting the reference images.

The artificial intelligence and machine learning system 230 also supports evaluation of generated videos through multiple metrics, including text similarity (measuring alignment between generated content and text prompt), video similarity (comparing generated frames with ground truth), subject similarity (evaluating fidelity of generated subjects compared to reference images), face similarity (assessing preservation of facial features), and dynamic degree (measuring natural motion in generated videos). For multi-subject evaluation, the artificial intelligence and machine learning system 230 segments subjects from both generated (e.g., synthesized) and ground truth videos, then computes similarity metrics for each subject separately, providing a more accurate assessment than whole-image comparison methods.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data, for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained during machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

The neural network architecture implemented for avatar animation may include specialized components like Generative Adversarial Networks (GANs) that can generate realistic facial animations, and Recurrent Neural Networks (RNNs) that can process the temporal aspects of speech. The model learns to generate smooth, natural-looking animations that accurately reflect the timing and characteristics of the input speech. In the prediction phase, when processing new user speech input, the trained model analyzes the audio features and generates corresponding avatar animations in real time. The model can handle various speech modifications, including language translation and emotional style changes, by learning correlations between different speech patterns and appropriate animation responses. This enables the system to generate realistic avatar animations without requiring complex tracking or modeling systems. The training process also incorporates techniques for handling different avatar types and customization options. The model learns to adapt the generated animations to different avatar facial structures while maintaining natural movement patterns. This allows the system to work effectively with avatars that have visual features representing the user or their friends, while ensuring consistent and realistic animation quality.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

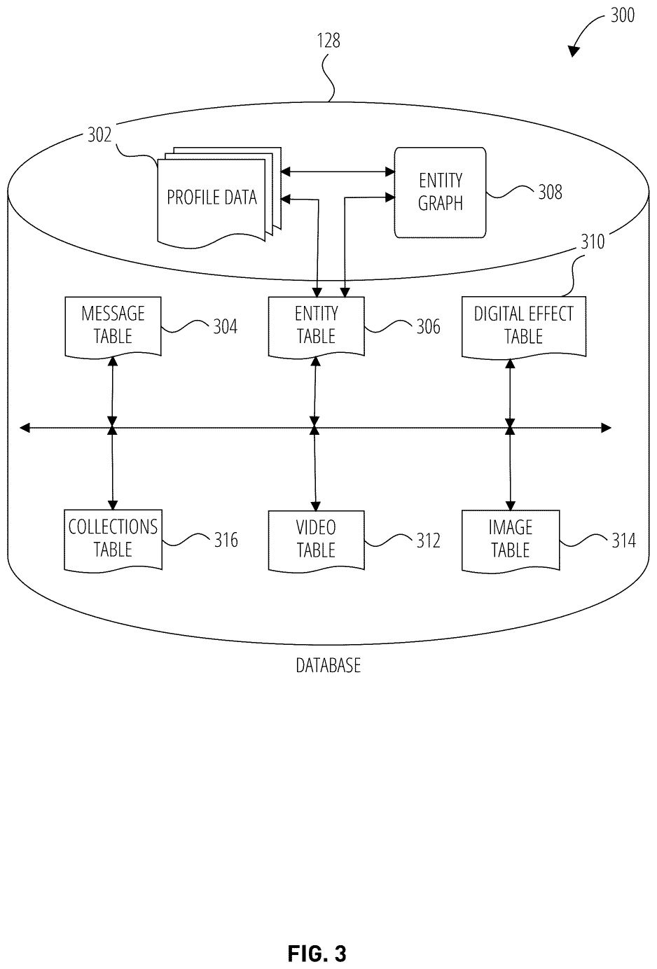

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314). For example, the database 128 stores several types of data used for multi-subject personalization in video generation by the video generation system 502, particularly for training data collection and model operation.

For training data collection, the database 128 stores video data in the video table 312, which contains the training videos used to extract frames for reference images and ground truth videos for model training. These videos are used for the supervised learning approach where the diffusion model learns to generate personalized videos by comparing its outputs with actual videos. Image data can be stored in the image table 314, including segmented subject images extracted from video frames using localization algorithms, object images isolated from videos, clean background images created through inpainting after removing subjects, and/or reference images with various augmentations applied (downscaling, blurring, color jittering, and so forth) to prevent overfitting. Digital effect data in the digital effect table 310 can include overlays and filters that can be applied to videos and images, instructions that define digital effects experiences, and/or sets of augmentation parameters used to modify reference images during training.

The database 128 also includes an ML model update database that stores associations between tasks, base ML models, and parameter updates. This includes entries that link task identifiers with base ML model identifiers and update identifiers, enabling efficient lookup and retrieval of appropriate model components when users select particular tasks.

Additionally, the database 128 stores entity information in the entity table 306, which maintains records about individuals and other entities appearing in videos, and collections data in the collections table 316, which organizes sets of messages and associated media content. These tables help establish relationships between subjects, objects, and backgrounds in the training data, supporting the binding mechanism that associates reference images with corresponding entity words in text prompts.

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

The collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The databases 128 also include a list of digital effects experiences along with their respective sets of instructions (that define their operation) and/or code that is executed by tracking systems to provide outputs of the digital effects experiences.

### Data Communications Architecture

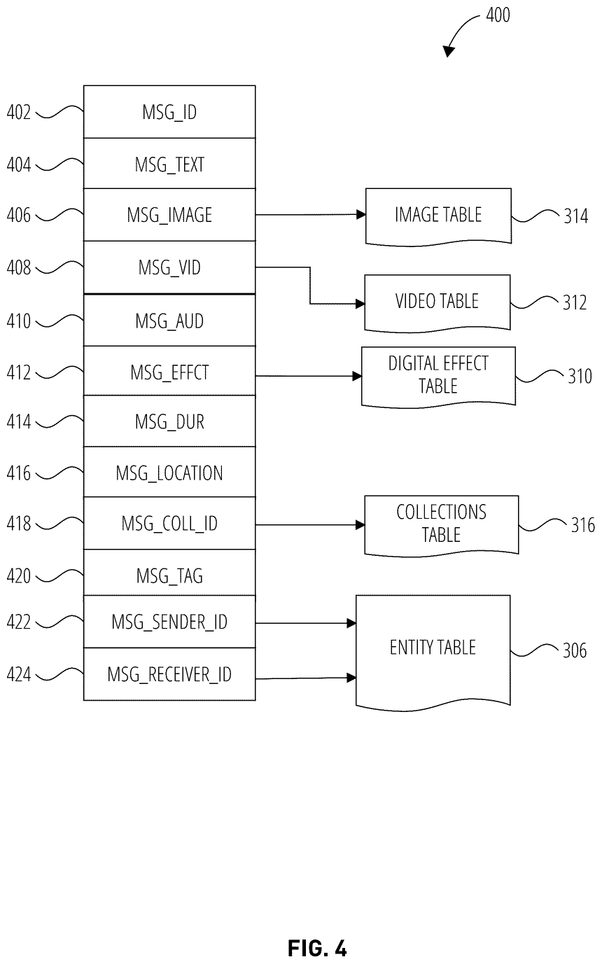

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 312, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

FIG. 5 illustrates a diagram of a video generation system 502, according to some examples. In some examples, the video generation system 502 is designed for multi-subject personalization in video generation. The video generation system 502 enables users to generate personalized videos that preserve the identity of specific subjects while allowing for natural motion and pose variations. Specifically, the video generation system 502 provides an intuitive interface for creating personalized videos featuring specific subjects with natural motion. The video generation system 502 begins with the user providing three key inputs through the interaction client 104 on their user system 102.

First, the user enters a text prompt 522 describing the desired video content (e.g., using voice input and/or a keyboard or other input component), such as, “A man in a white shirt with short gray hair stands still in a well-lit room, with black walls and shelves, crossing his arms . . . ” This text prompt guides the overall scene, actions, and environment of the generated video. Second, the user uploads multiple reference images that represent specific subjects, objects and/or elements the user wants to appear in the synthesized video. As shown in FIG. 5, these reference images include a first reference image 530 of a “man,” a second reference image 532 showing “short gray hair,” and a third reference image 534 depicting a “well-lit room.” These reference images provide visual characteristics that will be preserved in the final video. Third, the user provides binding information that explicitly associates each reference image with its corresponding entity word in the text prompt. This step allows the video generation system 502 to understand which image should influence which part of the video, preventing misalignment issues such as placing a human face on a dog.

Once these inputs are received, the video generation system 502 processes the inputs through several components, including the diffusion model 512 and the text encoder 524. The text encoder 524 converts the text prompt into text embeddings 526, while the shared image encoder 536 extracts features from each reference image. The video generation system 502 then fuses these features with the corresponding text embeddings through the linear projection network 538 and adds index embeddings (540, 542) to distinguish between different reference images. The video generation system 502 then generates an initial noisy video 504 and processes it through the video encoder 506 and tokenizer. The diffusion model 512, consisting of multiple diffusion transformer (DiT) blocks with self-attention layer 518 and cross-attention layers (first cross-attention layer 514 and second cross-attention layer 516), gradually de-noises this noisy video 504 by conditioning on both the text embeddings and personalization embeddings 544. After iterative refinement, the video decoder 508 produces the final synthesized video 510 that preserves the identity of subjects from the reference images while showing natural motion and pose variations.

This user-friendly approach eliminates the need for time-consuming test-time optimization required by conventional methods, allowing users to quickly generate personalized videos featuring multiple subjects and backgrounds with just a text prompt, reference images, and binding information.

In some cases, to begin with, the video generation system 502 processes an input noisy video 504, which serves as the starting point for the generation process. This noisy video is initially processed by a video encoder 506 that compresses the video into a more manageable representation for efficient processing, such as using video tokens. Furthermore, the video generation system 502 employs a tokenizer component that converts the encoded video into a sequence of discrete tokens, which are then processed through a series of DiT blocks. These blocks form the core of the diffusion model 512 that gradually de-noises the video.

The video generation system 502 includes a diffusion model 512 that contains three primary components. The diffusion model 512 includes the self-attention layer 518, the first cross-attention layer 514, and the second cross-attention layer 516. The self-attention layer 518 allows the diffusion model 512 to capture relationships between different parts of the video, enabling coherent generation across frames.

The text conditioning component 520 processes a text prompt 522 such as “A man in a white shirt with short gray hair stands still in a well-lit room, with black walls and shelves, crossing his arms . . . ” through a text encoder 524 to produce text embeddings 526. These embeddings 526 guide the generation process by specifying what content should appear in the video. The personalization conditioning component 528 processes multiple reference images, including a first reference image 530 (depicting “man”), a second reference image 532 (depicting “short gray hair”), and a third reference image 534 (depicting “well-lit room”). These images provide visual references for specific entities mentioned in the text prompt 522. Consequently, each reference image 530, 532, 534 is processed by a shared image encoder 536 that extracts visual features from the images. This shared architecture ensures consistent feature extraction across different reference images.

Subsequently, the extracted features are processed through a shared linear projection network 538, which aligns the image features with the corresponding text embeddings. This projection helps establish the binding between visual and textual representations. The video generation system 502 adds index embeddings (first index embedding 540, second index embedding 542, and so forth) to distinguish between different reference images. This ensures that the diffusion model 512 can correctly associate each reference image with its corresponding entity in the text prompt 522.

Following this, the personalization embeddings 544 are created by concatenating the processed features from all reference images. These embeddings are then fed into the second cross-attention layer 516 to condition the diffusion process. After iterative denoising through multiple DiT blocks, the processed tokens are reshaped and decoded by a video decoder 508 to produce the final synthesized video 510. This synthesized video 510 maintains the identity characteristics of the reference images while exhibiting natural motion.

For example, the personalization embeddings 544 are created by concatenating the processed features from all reference images. This concatenation process follows specific mathematical formulations. For each reference image, the system first extracts image tokens In ∈ [symbol] l×d using a shared image encoder 536, where l represents the number of tokens per reference image and d represents the dimension of each token. The system then retrieves word tokens Cn from the text embeddings c and flattens them into a 1-D embedding. Since entity words vary in length, the system zero-pads or truncates these word embeddings to maintain consistent dimensions. To create the binding between image and text, the system replicates the flattened word tokens l time and concatenates them with the image tokens along the channel axis, represented mathematically as Concat(In, Repeat(Cn, l)).

This concatenated representation is then processed through a linear projection module, followed by a residual connection with the original image tokens In, expressed as fn=In+Linear(Concat(In, Repeat(Cn, l))). A learnable image index embedding is added to separate tokens from different images, with tokens from the same image sharing identical index embeddings. The final personalization embeddings f are created by concatenating all individual embeddings: f=Concat(f1, . . . , fn, . . . , fN), where N is the total number of reference images.

These personalization embeddings 544 are fed into the second cross-attention layer 516, which computes attention scores between video tokens and personalization embeddings according to the equation Attention(Q, K, V)=softmax(QK\hat{ }T/√d)V, where Q represents queries from video tokens, while K and V are keys and values derived from personalization embeddings.

The diffusion model 512 follows a rectified flow formulation for the denoising process, iteratively refining the video through multiple steps. At each timestep t, the diffusion model 512 predicts the noise εθ(xt, t, c, f) to be removed from the current noisy video xt, where c represents text embeddings and f represents personalization embeddings. The denoising update is performed according to xt−1=xt−εθ(xt, t, c, f).

After multiple denoising iterations through the DiT blocks, the processed tokens are reshaped and decoded by the video decoder 508 to produce the final synthesized video 510. The video decoder 508 transforms the denoised latent representation back into pixel space, generating a video that maintains the identity characteristics of the reference images while exhibiting natural motion patterns that weren't present in the static reference images.

During inference, the video generation system 502 starts with a completely noisy video and progressively refines it by conditioning on both the text prompt 522 and the personalization embeddings 544. This dual conditioning ensures that the generated video aligns with the textual description while incorporating the visual characteristics of the reference images.

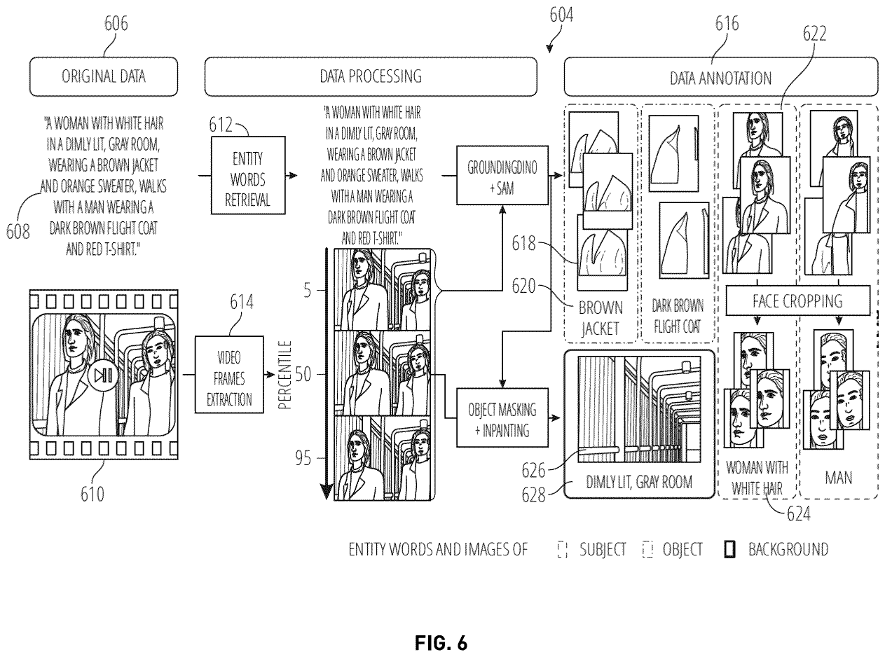

For training the model, the video generation system 502 uses a comprehensive dataset of videos and their corresponding captions. These can be generated by the training data generation system 604. As explained below with respect to FIG. 6, the training process begins with collecting video-caption pairs and processing them to create training data. Initially, entity words (subjects, objects, backgrounds) are retrieved from captions using a LLM. Multiple frames are selected from each video, and localization algorithms segment subjects and objects from these frames.

Clean background images are created by removing segmented subjects and applying inpainting algorithms. This provides separate reference images for subjects, objects, and backgrounds that can be used for training. The diffusion model 512 can be trained in two stages. In the first stage, the diffusion model 512 is trained with only text conditioning. In the second stage, an additional cross-attention layer for personalization conditioning is introduced, and the whole diffusion model 512 is fine-tuned with warmup.

During training, the diffusion model 512 learns to de-noise videos by starting with a purely noisy video, iteratively denoising it using both text and image conditioning, computing the deviation between the generated video and ground truth video, and updating parameters based on this deviation. To prevent overfitting, data augmentation techniques are applied to reference images, including downscaling, Gaussian blurring, color jittering, brightness adjustment, horizontal flipping, image shearing, and rotation. These techniques help the diffusion model 512 focus on subject identity rather than unintended properties like lighting or pose.

One important feature in the training process is the binding mechanism that associates reference images with corresponding entity words in text prompts. After extracting features from reference images, the video generation system 502 fuses these features with text embeddings of the corresponding entity words. This binding is implemented by retrieving word tokens from text embeddings, replicating and concatenating them with image tokens, passing them through the shared linear projection network 538, and adding learnable image index embeddings to separate tokens from different images.

The video generation system 502 is evaluated using a comprehensive benchmark that supports various conditioning scenarios including face crops, single or multiple subjects, and both foreground and background conditioning. The evaluation metrics include text similarity, video similarity, subject similarity, face similarity, and dynamic degree. For multi-subject evaluation, the video generation system 502 segments subjects from both generated and ground truth videos, then computes similarity metrics for each subject separately, providing a more accurate assessment than whole-image comparison methods.

FIG. 6 illustrates a diagram of a training data generation system 604, according to some examples. Specifically, the training data generation system 604 automatically creates high-quality training data for the multi-subject personalization video generation model (e.g., the diffusion model 512). This training data generation system 604 enables the collection and processing of video-caption pairs to create comprehensive training datasets that teach the model to preserve subject identity while allowing for natural motion.

In some examples, the training data generation system 604 begins with original data 606, which includes an individual training video 610 paired with an individual training text prompt 608 (e.g., a caption). As shown in FIG. 6, the original data 606 might include a video of “A woman with white hair in a dimly lit, gray room, wearing a brown jacket and orange sweater, walks with a man wearing a dark brown flight coat and red T-shirt.” Furthermore, the training data generation system 604 processes this original data 606 through a data processing component that includes entity word retrieval 612 (e.g., an LLM) and video frame extraction component 614. The entity word retrieval 612 can use an LLM to identify specific entity words from the caption, categorizing them as subjects (e.g., “woman with white hair,” “man”), objects (e.g., “brown jacket,” “dark brown flight coat”), and/or backgrounds (e.g., “dimly lit, gray room”).

Additionally, the video frame extraction component 614 selects multiple frames from the video at different percentiles (5%, 50%, and 95%), capturing the subjects in various poses and lighting conditions throughout the video. This provides diverse reference images for training the model. Subsequently, the data annotation component 616 processes these extracted frames using localization algorithms or processes. The system employs GroundingDINO and SAM (Segment Anything Model) to detect and segment subjects and objects from the frames, creating a first set of reference images 618, a second set of reference images 622 (e.g., “woman with white hair”), and a background reference image 626 (e.g., “dimly lit, gray room”). Moreover, the system creates a clean background (e.g., background reference images 626) through object masking and inpainting. After segmenting the subjects and objects from the frames, the system removes them and applies an inpainting algorithm to create a clean background reference image (e.g., “dimly lit, gray room”).

For example, in the training data generation system 604, the process of extracting only the portion of the video frame that matches the corresponding text involves several sophisticated steps to ensure accurate subject-text alignment. The process begins with the entity word retrieval 612, which uses the LLM to identify specific entity words from the caption, categorizing them as subjects (e.g., “woman with white hair”), objects (e.g., “brown jacket”), and backgrounds (e.g., “dimly lit, gray room”). This categorization is important as it establishes which portions of the video frames need to be extracted for each entity word. Next, the video frame extraction component 614 strategically selects multiple frames from the video at different percentiles (5%, 50%, and 95%), capturing the subjects in various poses and lighting conditions throughout the video. This temporal sampling ensures diversity in the reference images by capturing the subject at different moments in the video sequence, which helps prevent the model from overfitting to a single pose or lighting condition.

The data annotation component 616 then processes these extracted frames using advanced localization algorithms. Specifically, the system employs GroundingDINO and SAM (Segment Anything Model) to detect and segment the exact portions of the frames that correspond to each entity word. GroundingDINO first identifies the bounding boxes for each entity mentioned in the text prompt, precisely locating where in the frame each subject or object appears. Then, SAM generates accurate masks for these regions, enabling pixel-perfect segmentation of the subjects from the background. For example, when processing a frame containing a “woman with white hair” and a “brown jacket,” the system doesn't extract the entire frame. Instead, it creates separate segmented images: one containing only the woman (second set of reference images 622) and another containing only the brown jacket (first set of reference images 618). This precise segmentation ensures that each reference image contains only the specific entity mentioned in the corresponding text, without including irrelevant portions of the frame.

For background elements, the system applies object masking and inpainting. After segmenting and removing all subjects and objects from the middle frame (50% percentile), an inpainting algorithm fills in the masked areas to create a clean background reference image (e.g., background reference image 626; e.g., “dimly lit, gray room”). This process ensures that the background image contains no traces of the foreground subjects. Additionally, for human subjects, the system performs face cropping to extract facial regions, enabling more precise personalization of human faces in the generated videos. These face crops are particularly important for preserving facial identity in the final outputs.

This meticulous extraction process ensures that only the relevant portions of video frames that match the corresponding text are used as reference images, enabling the model to learn precise associations between textual descriptions and visual characteristics while maintaining the ability to generate natural motion and pose variations in the final videos. For example, the first set of reference images 618 can be associated with the first portion of text 620, the second set of reference images 622 can be associated with the second portion of text 624, and the background reference image 626 can be associated with the third portion of text 628.

In some cases, the training data generation system 604 also performs face cropping for human subjects, extracting facial regions to enable more precise personalization of human faces in the generated videos. This is particularly important for preserving facial identity in the final outputs.

The data annotation component 616 organizes the extracted images into three categories, subject, object, and background, optionally visually distinguishing each text portion by its corresponding category (e.g., using different colors). This categorization helps the model understand the role of each reference image during training.

For training purposes, the system applies data augmentation to the reference images (e.g., the first set of reference images 618, second set of reference images 622, and background reference image 626). This includes techniques such as downscaling, Gaussian blurring, color jittering, brightness adjustment, horizontal flipping, image shearing, and rotation. These augmentations prevent the model from overfitting to unintended properties of the reference images, such as specific lighting conditions or poses.

The final output of the training data generation system 604 is a comprehensive set of entity words and their corresponding reference images, organized by type (subject, object, background). This structured data enables the model to learn the association between text descriptions and visual characteristics while maintaining the ability to generate natural motion and pose variations.

During model training, this generated data is used to teach the diffusion model to de-noise videos by comparing its outputs with ground truth videos. The model learns to preserve the identity characteristics from the reference images while generating natural motion, effectively binding each reference image to its corresponding entity word in the text prompt.

For example, the training process for the diffusion model 512 begins with the original data 606 shown in FIG. 6, which includes an individual training video 610 and its corresponding individual training text prompt 608. For example, the prompt “A woman with white hair in a dimly lit, gray room, wearing a brown jacket and orange sweater, walks with a man wearing a dark brown flight coat and red T-shirt” can be used. During the training process, the video generation system 502 generates a noisy version of the ground truth video (the individual training video 610). The diffusion model 512 then attempts to de-noise this video by conditioning on both the text prompt 608 and the personalization embeddings created from the reference images.

The personalization embeddings are created by binding each reference image (e.g., from the training data including the first set of reference images 618, second set of reference images 622, and background reference image 626) with its corresponding entity word in the text prompt 608 (e.g., first portion of text 620, second portion of text 624, and third portion of text 628). For example, the system binds the segmented image of the woman (e.g., the second set of reference images 622) with the phrase “woman with white hair” in the text prompt (e.g., second portion of text 624). This binding is important for ensuring that the diffusion model 512 correctly associates each reference image with the appropriate entity in the generated video.

The diffusion model 512 processes these inputs through separate cross-attention layers—one layer for text conditioning and another for personalization conditioning. This architectural design allows the model 512 to balance text alignment and image fidelity more effectively than using a single shared layer.

Specifically, the architecture employs two separate cross-attention layers (e.g., first cross-attention layer 514 and second cross-attention layer 516) that process different types of conditioning data, working in conjunction with the self-attention layer 518 to generate personalized videos. The first cross-attention layer 514 specifically receives text embeddings 526 that are generated by the text encoder 524 from the text prompt 522 (e.g., “A man in a white shirt with short gray hair stands still in a well-lit room . . . ”). This first cross-attention layer 514 focuses exclusively on aligning the generated video with the textual description, ensuring that the overall scene, actions, and environment match what was described in the prompt. The second cross-attention layer 516 receives the personalization embeddings 544, which are created by concatenating the processed features from all reference images after they have been bound with their corresponding entity words. These personalization embeddings 544 contain the visual characteristics of specific subjects (like “man,” “short gray hair”) and backgrounds (like “well-lit room”) that need to be preserved in the final video.

The self-attention layer 518 works in conjunction with the first cross-attention layer 514 and second cross-attention layer 516 by capturing relationships between different parts of the video tokens themselves. While the cross-attention layers incorporate external conditioning information (text and images), the self-attention layer 518 allows the diffusion model 512 to maintain temporal and spatial coherence across the video frames. This architectural separation is important because it allows the diffusion model 512 to balance text alignment and image fidelity more effectively than using a single shared layer for both types of conditioning. If text and image tokens were processed through the same cross-attention layer, the image tokens would tend to dominate due to their typically longer sequence length, potentially reducing alignment with the text prompt. By processing them separately, the diffusion model 512 can apply different weights and attention patterns to each type of conditioning, resulting in videos that both match the text description and preserve the identity characteristics from the reference images.

The outputs from both cross-attention layers are combined and fed back into the diffusion process, guiding the iterative denoising of the video tokens. This combined conditioning ensures that the generated video maintains both textual accuracy and visual fidelity to the reference images while allowing for natural motion and pose variations.

After each denoising step, the system computes the deviation between the de-noised video and the ground truth video (the individual training video 610). This deviation is used to update the parameters of the diffusion model 512 through gradient descent optimization, with gradient clipping applied to ensure stable training. The training process involves multiple iterations of this denoising procedure, with the model gradually learning to generate videos that preserve the identity characteristics from the reference images while exhibiting natural motion patterns similar to those in the ground truth video.

To evaluate the model's performance during training, the system segments subjects from both the generated video and the ground truth video, then computes similarity metrics for each subject separately. This subject-level evaluation provides a more accurate assessment than whole-image comparison methods, especially for videos containing multiple subjects.

In one example, consider a video containing both a person and a dog. The system first segments the person from both the generated video and the ground truth video using localization algorithms like GroundingDINO and SAM. The video generation system 502 then computes the subject similarity metric by measuring the average cosine similarity between the reference image of the person and the segmented person in the generated video frames. This focused evaluation ensures that the assessment specifically measures how well the model preserved the identity characteristics of the person, without being influenced by other elements in the video.

Similarly, for a video containing multiple human subjects with different characteristics, the system separately segments each individual from both the generated and ground truth videos. For each subject, it computes dedicated similarity metrics, allowing the system to evaluate how well the model preserved the unique identity of each person independently. This approach is particularly valuable when subjects have varying levels of visibility or importance in the scene, as it prevents a well-generated primary subject from masking issues with secondary subjects.

In another example involving a human subject and background personalization, the video generation system 502 not only segments and evaluates the human subject but also separately evaluates the background fidelity. By computing distinct metrics for the subject and background, the video generation system 502 can determine whether the diffusion model 512 is effectively preserving both foreground identity and background characteristics. This is used for scenarios where users want to place specific subjects in particular environments, such as placing a person on the Moon's surface or in a desert landscape.

For videos featuring faces, the video generation system 502 employs face detection algorithms to extract face crops from both the generated and ground truth videos. The video generation system 502 then computes a face similarity metric using specialized face recognition features (such as ArcFace), which are particularly sensitive to facial identity characteristics. This enables precise evaluation of how well the model preserves facial identity, which is often the most important aspect of human subject personalization. If a face is missing in any frame of the generated video, that frame receives a similarity score of zero, ensuring that the evaluation penalizes failures to generate the required subjects throughout the video sequence.

Through this iterative training process using the data generated from FIG. 6, the diffusion model 512 learns to preserve the identity characteristics from reference images while generating natural motion, effectively binding each reference image to its corresponding entity word in text prompts. This enables the model to generate personalized videos featuring specific subjects with natural motion and pose variations.

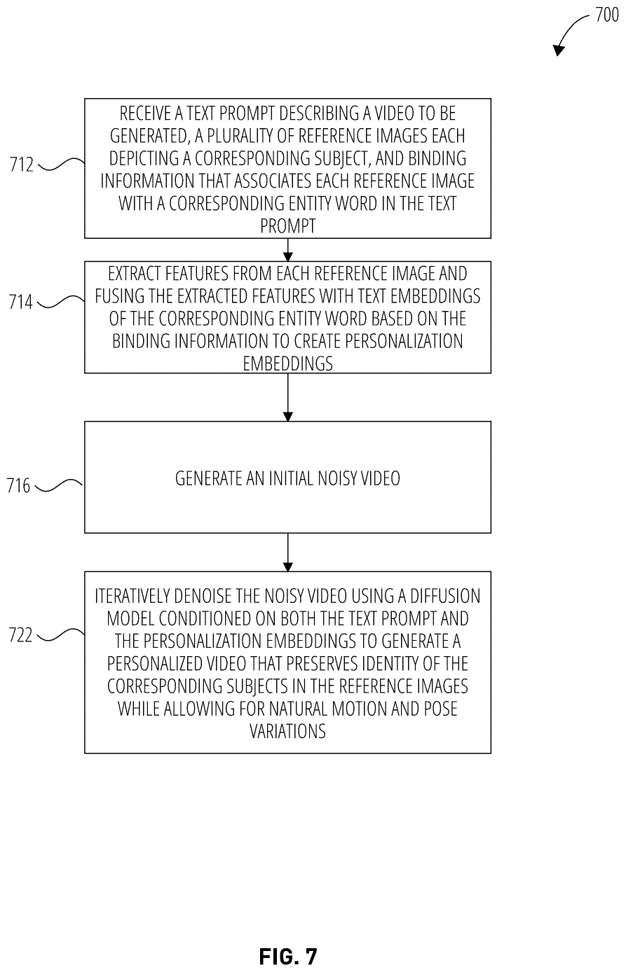

FIG. 7 is a flowchart illustrating routine 700 (e.g., a method or process), according to some examples. Although the example method depicted in FIG. 7 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 712, the video generation system 502 receives a text prompt describing a video to be generated, a plurality of reference images each depicting a corresponding subject, and binding information that associates each reference image with a corresponding entity word in the text prompt. From a user perspective, the system begins by receiving these three inputs through the interaction client 104 on the user system 102. The text prompt 522 describes the desired video content (e.g., “A man in a white shirt with short gray hair stands still in a well-lit room, with black walls and shelves, crossing his arms . . . ”). This text prompt 522 guides the overall scene, actions, and environment of the generated video.

The plurality of reference images includes images representing specific subjects or elements the user wants to appear in the video, such as a first reference image 530 of a “man,” a second reference image 532 showing “short gray hair,” and a third reference image 534 depicting a “well-lit room.” These reference images provide visual characteristics that will be preserved in the final video.

The binding information explicitly associates each reference image with its corresponding entity word in the text prompt 522. This step allows the system to understand which image should influence which part of the video, preventing misalignment issues such as placing a human face on a dog.

After receiving these inputs, in operation 714, the video generation system 502 extracts features from each reference image and fuses the extracted features with text embeddings of the corresponding entity word based on the binding information to create personalization embeddings. This process involves encoding the images using a shared image encoder 536 and binding them with their corresponding text embeddings through a shared linear projection network 538.

At operation 716, the video generation system 502 generates an initial noisy video. This operation involves creating a completely random noise pattern that will serve as the starting point for the iterative denoising process. The system first tokenizes the video into a sequence of 1-D video tokens and then adds Gaussian noise to these tokens to obtain the initial noisy video. Using a video encoder and tokenizer, the system compresses the video representation into fewer tokens to make computation more efficient. The system then adds Gaussian noise to these video tokens following the rectified flow formulation. At the beginning of the generation process, the initial video is “totally noise”. This initial noisy video serves as the starting point for the iterative denoising process that follows in operation 722, where the diffusion model gradually removes noise while being conditioned on both the text prompt and personalization embeddings. The model starts with pure noise and progressively denoises it to generate a coherent video that matches the text description and reference images.

At operation 722, the video generation system 502 iteratively de-noises the noisy video using a diffusion model conditioned on both the text prompt and the personalization embeddings to generate a personalized video that preserves identity of the corresponding subjects in the reference images while allowing for natural motion and pose variations. For example, at operation 722, the video generation system 502 implements a sophisticated iterative denoising process that transforms the initial noisy video into a high-quality personalized video through multiple refinement steps.

The iterative denoising process begins with the completely noisy video generated in operation 716 and progressively refines it through a series of denoising steps. During each step, the diffusion model 512 processes the current state of the video through multiple DiT (Diffusion Transformer) blocks, each containing a self-attention layer 518 and two cross-attention layers (514 and 516). The first cross-attention layer 514 conditions the denoising process on the text embeddings 526 derived from the text prompt 522, ensuring that the generated video aligns with the textual description provided by the user. Simultaneously, the second cross-attention layer 516 conditions the process on the personalization embeddings 544, which contain the visual characteristics of the reference images bound to their corresponding entity words.

This dual conditioning is important for achieving the balance between text alignment and image fidelity. By processing text and image conditioning through separate cross-attention layers, the system prevents the image tokens from dominating the generation process, which could otherwise reduce alignment with the text prompt. This architectural design enables the model to generate videos that both match the text description and preserve the identity characteristics from the reference images.

The denoising process follows a rectified flow formulation, where each step reduces the amount of noise in the video while maintaining the identity characteristics of the subjects. The system applies classifier-free guidance separately for text and image conditioning, using different guidance scale values to balance text alignment and image fidelity. Typically, a higher guidance scale is used for text conditioning (around 8) and a lower scale for image conditioning (around 3) to prevent the model from simply copying and pasting the reference images into the video.

As the de-noising progresses through multiple iterations, the video gradually becomes clearer and more coherent. The early iterations establish the basic structure and composition of the scene, while later iterations refine details such as facial features, textures, and lighting. This progressive refinement allows the model to generate videos that preserve the identity of subjects from the reference images while introducing natural motion and pose variations that weren't present in the static reference images.

The preservation of identity while allowing for natural motion is one of the key innovations of this system. Unlike conventional approaches that often suffer from the “copy-and-paste effect” where models directly replicate reference images without natural variations, this system generates videos where subjects maintain their identity characteristics (such as facial features, clothing, or distinctive attributes) while exhibiting realistic movements and pose changes.

The final output of operation 722 is a synthesized video 510 that successfully balances multiple objectives. The synthesized video 510 aligns with the text prompt, preserves the identity of subjects from the reference images, exhibits natural motion and pose variations, and maintains temporal coherence throughout the video sequence.

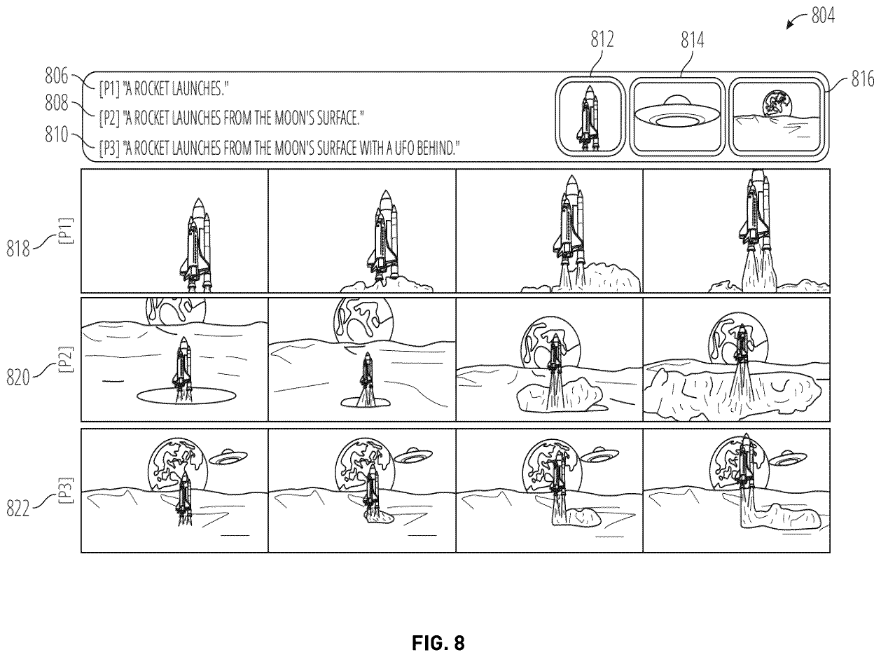

FIG. 8 illustrates example inputs and outputs of the video generation system 502, according to some examples. Specifically, FIG. 8 illustrates example inputs and outputs of the video generation system 502, demonstrating how the system processes different text prompts and reference images to generate personalized videos (e.g., synthesized videos).

The diagram 804 shows a comprehensive example of the system's capabilities through three different scenarios. The diagram 804 displays a collection of inputs including text prompts (e.g., a first text prompt 806, second text prompt 808, and third text prompt 810) and reference images (e.g., a first reference image 812, second reference image 814, and third reference image 816). Each reference image is marked or tagged in a specific way to bind it with one or more words that are in the corresponding text prompts. This can be performed using different colors or other markings.

In the first example, the system receives a simple first text prompt 806 stating “A rocket launches.” This basic prompt is paired with the first reference image 812, the second reference image 814, and the third reference image 816 that include visual representations of a rocket, the Moon, and a UFO. The system processes these inputs to generate a personalized first generated video 818 labeled as [P1].

In the second example, the system receives a more detailed second text prompt 808 stating “A rocket launches from the Moon's surface.” This prompt provides additional context about the location of the rocket launch. Using the same reference images 812, 814, and 816, the system generates a second generated video 820 labeled as [P2] that incorporates both the rocket and the lunar surface elements.

In the third example, the system processes an even more complex third text prompt 810 stating “A rocket launches from the Moon's surface with a UFO behind.” This prompt specifies not only the location but also introduces an additional element (the UFO) and its spatial relationship to the rocket. The system generates a third generated video 822 labeled as

that incorporates all three elements, the rocket, the Moon's surface, and the UFO positioned behind the rocket.

The following are additional examples not shown in FIG. 8. Specifically, in a fourth example, the system receives a text prompt stating “A woman pets a dog on sea ice.” This prompt is paired with reference images that include visual representations of a specific woman with blonde hair, a golden retriever dog, and a panoramic view of Arctic sea ice with blue tones. The binding information associates the woman image with the word “woman,” the dog image with the word “dog,” and the ice image with the phrase “sea ice.” The system generates a personalized video that shows the specific woman petting the golden retriever while both are standing on realistic-looking sea ice, with natural motion as the woman reaches down to interact with the dog and the dog responds with tail wagging.

In a fifth example, the system processes a more complex text prompt stating “A chef in a white hat prepares pasta in a rustic Italian kitchen with brick walls.” The user provides reference images of a specific chef (bound to “chef”), a distinctive white chef's hat (bound to “white hat”), and a warm-toned brick-walled kitchen (bound to “rustic Italian kitchen with brick walls”). The system generates a video showing the chef wearing the specific white hat while performing cooking motions to prepare pasta, with the distinctive brick-walled kitchen environment maintained throughout the video. The binding mechanism ensures that the chef's identity, the specific hat design, and the kitchen's distinctive features are all preserved while allowing for natural cooking movements.

In a sixth example, the system handles a fantasy-oriented prompt: “A dragon flies over a medieval castle during sunset.” The user provides reference images of a specific dragon design with purple scales (bound to “dragon”), a European-style castle with distinctive towers (bound to “medieval castle”), and a dramatic orange-red sunset sky (bound to “sunset”). Using color-coded binding markers, the system clearly understands which visual elements correspond to which parts of the text. The resulting video shows the specific dragon design flying with realistic wing movements over the distinctive castle, all bathed in the warm glow of the sunset lighting. The system maintains the identity characteristics of each element while generating natural flying motion for the dragon and subtle environmental effects like clouds moving in the sunset sky.

Beyond color coding, users can bind text to images through several intuitive methods in the video generation system. One approach involves using a graphical user interface where users can directly drag and drop reference images onto corresponding words in the text prompt, creating explicit visual connections between images and text elements. Alternatively, the system can provide a structured form interface where users enter the text prompt in one field and then upload each reference image with an accompanying text field to specify which word or phrase it corresponds to.

The system also supports numerical tagging, where each entity word in the text prompt is assigned a number, and the corresponding reference images are labeled with matching numbers. For more technical users, the system allows binding through a JSON-like format where users can define a structured data object that pairs each entity word with its corresponding image file path or identifier.

Another method involves interactive text highlighting, where users first highlight specific words or phrases in the text prompt and then select the corresponding reference image from their gallery, creating an explicit binding that the system stores as metadata. The system can also provide a split-screen interface where the text prompt appears on one side with selectable words, and reference images appear on the other side, allowing users to create connections by selecting a word and then clicking on the corresponding image.

These additional examples demonstrate the system's versatility in handling different types of subjects (humans, animals, fantasy creatures), environments (natural landscapes, indoor settings, historical structures), and complex interactions between multiple elements, all while maintaining the identity characteristics specified in the reference images. The progression from a simple prompt to more complex ones illustrates the flexibility of the system in handling various levels of detail in the text descriptions while maintaining the visual characteristics of the reference images in the generated videos.

### System With Head-Wearable Apparatus

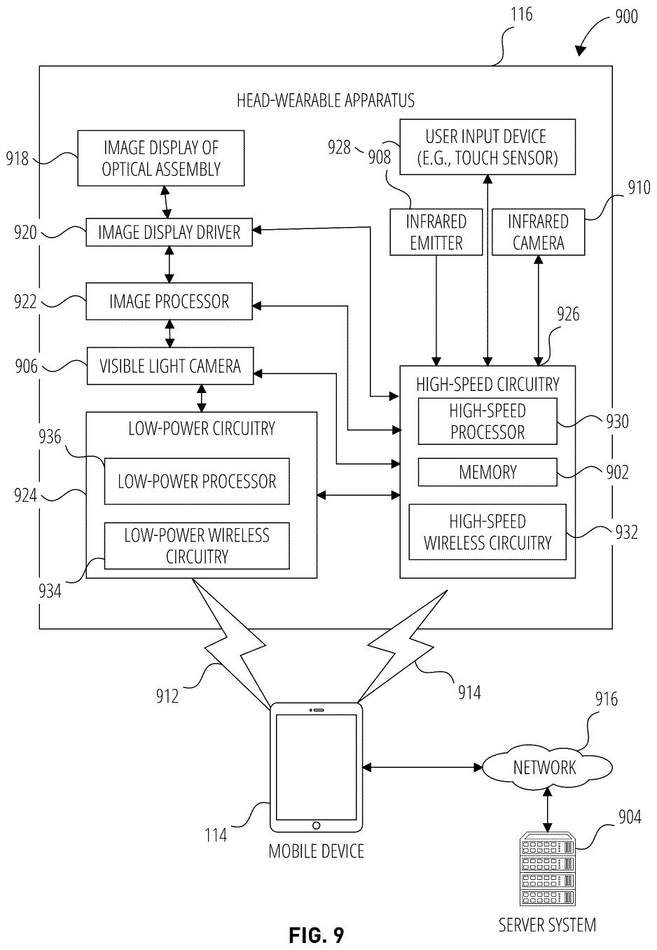

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110 of FIG. 1) via various networks (Network 916 or Network 108 of FIG. 1.

The head-wearable apparatus 116 includes one or more cameras, each of which may be, for example, a visible light camera 906, an infrared emitter 908, and an infrared camera 910.

The mobile device 114 connects with head-wearable apparatus 116 using both a low-power wireless connection 912 and a high-speed wireless connection 914. The mobile device 114 is also connected to the server system 904 and the network 816.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed processor 930 to drive the left and right image displays of the image display of optical assembly 918. The high-speed processor 930 may be any processor capable of managing high-speed communications and operation of any general computing system needed for the head-wearable apparatus 116. The high-speed processor 930 includes processing resources needed for managing high-speed data transfers on a high-speed wireless connection 914 to a wireless local area network (WLAN) using the high-speed wireless circuitry 932. In certain examples, the high-speed processor 930 executes an operating system such as a LINUX operating system or other such operating system of the head-wearable apparatus 116, and the operating system is stored in the memory 902 for execution. In addition to any other responsibilities, the high-speed processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the Network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed processor 930 from the image processor 922 or the low-power processor 936 to the memory 902. In some examples, the high-speed processor 930 may manage addressing of the memory 902 such that the low-power processor 936 will boot the high-speed processor 930 any time that a read or write operation involving memory 902 is needed.

As shown in FIG. 9, the low-power processor 936 or high-speed processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the Network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a network communication interface coupled to the processor. The Network communication interface allows for communication over the Network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any input/output (I/O) components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

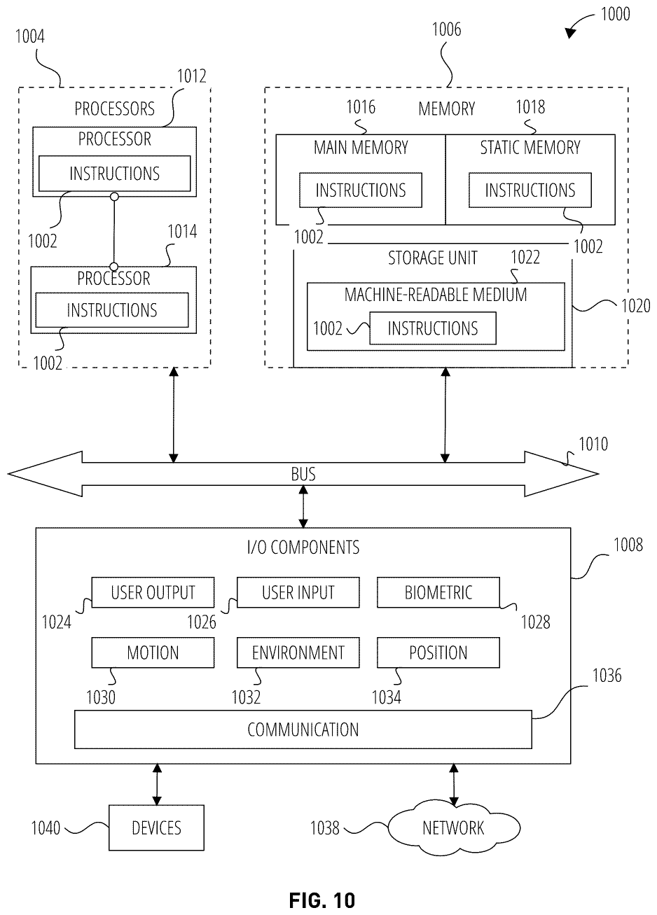

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 (e.g., processor 1012 or processor 1014 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a Network 1038 or devices 1040 via respective coupling or connections. For example, the communication components 1036 may include a network interface component or another suitable device to interface with the Network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

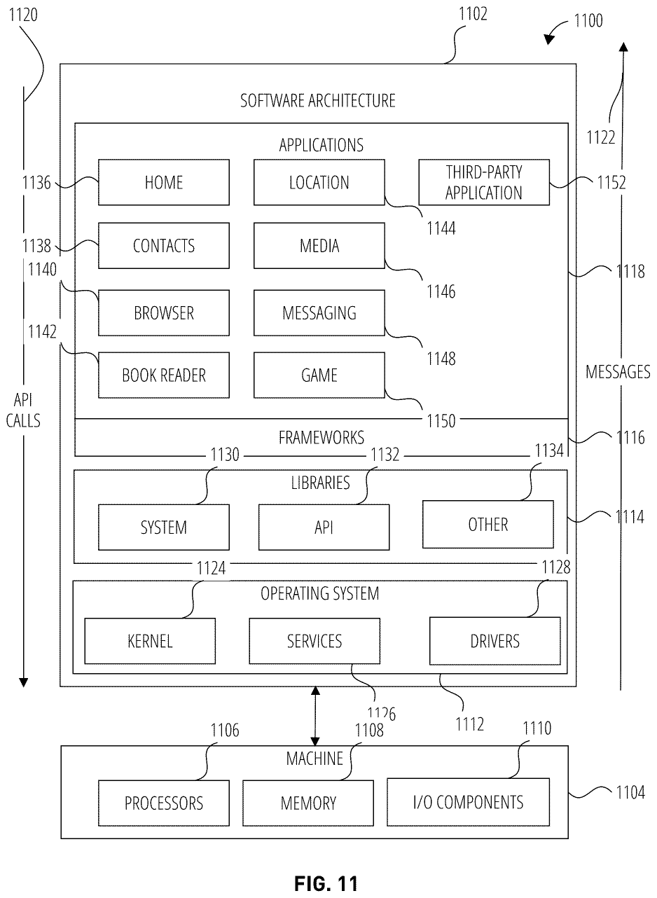

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: receiving a text prompt describing a video to be generated, a plurality of reference images each depicting a corresponding subject, and binding information that associates each reference image with a corresponding entity word in the text prompt; extracting features from each reference image and fusing the extracted features with text embeddings of the corresponding entity word based on the binding information to create personalization embeddings; generating an initial noisy video; and iteratively denoising the noisy video using a diffusion model conditioned on both the text prompt and the personalization embeddings to generate a personalized video that preserves identity of the corresponding subjects in the reference images while allowing for natural motion and pose variations.

Example 2. The system of Example 1, wherein the diffusion model comprises multiple cross-attention layers and a self-attention layer.

Example 3. The system of Example 2, the operations comprising: encoding each of the plurality of reference images into image tokens; projecting fused embeddings of each reference image and its corresponding entity word; applying a residual connection with the image tokens for each reference image; adding a learnable image index embedding to separate tokens from different reference images, wherein tokens from the same reference image share the same image index embedding; and concatenating the personalization embeddings from all reference images to create a combined personalization embedding for conditioning the diffusion model.

Example 4. The system of Example 3, the operations comprising: processing the combined personalization embedding by a first cross-attention layer of the multiple cross-attention layers; and processing the text embeddings by a second cross-attention layer of the multiple cross-attention layers.

Example 5. The system of any one of Examples 1-4, the operations comprising: applying data augmentation to the reference images before extracting the features to prevent the diffusion model from overfitting to unintended properties of the reference images.

Example 6. The system of any one of Examples 1-5, the operations comprising: encoding the initial noisy video into a set of video tokens using a video encoder; and decoding a de-noised set of video tokens back into a video using a video decoder.

Example 7. The system of any one of Examples 1-6, wherein the diffusion model is trained to perform a set of training operations comprising: accessing a plurality of training data, the plurality of training data comprising a plurality of videos depicting multiple subjects and corresponding captions associated with the plurality of videos; selecting an individual video from the plurality of training data along with an individual caption of the corresponding captions associated with the individual video; retrieving entity words from the individual caption using a large language model (LLM), wherein the entity words include subject entities and background entities; selecting multiple frames from the individual video; extracting individual images for individual subjects and a background from the selected multiple frames; binding each extracted individual image with its corresponding entity word in the individual caption to create a training personalization embedding; generating a training video using the diffusion model conditioned on both the individual caption and the training personalization embedding; computing a deviation between the training video and the selected individual video; and updating parameters of self-attention layers and cross-attention layers of the diffusion model based on the computed deviation.

Example 8. The system of Example 7, wherein updating the parameters comprises: applying a gradient descent optimization algorithm to minimize the deviation; and applying gradient clipping with a predetermined value to ensure stable training.

Example 9. The system of any one of Examples 7-8, the set of training operations comprising: creating clean background images as a portion of the extracted individual images by removing the subjects depicted in the selected multiple frames and applying inpainting; and applying data augmentation to the extracted individual images to prevent overfitting to unintended properties.

Example 10. The system of Example 9, the operations for applying data augmentation comprising: downscaling and applying Gaussian blurring to the extracted individual images to prevent overfitting to image resolution; and applying color jittering and brightness adjustment to mitigate overfitting on lighting conditions.

Example 11. The system of any one of Examples 9-10, the operations for applying data augmentation comprising: applying horizontal flip, image shearing, and rotation to the extracted individual images to weaken overfitting on the subject's pose; and applying random cropping to the extracted individual images to increase diversity during training.

Example 12. The system of any one of Examples 9-11, wherein computing the deviation comprises: encoding the individual video into video tokens; and comparing the encoded individual video tokens with denoised video tokens of the training video generated by the diffusion model.

Example 13. The system of any one of Examples 1-12, the operations comprising: tokenizing the video into a sequence of 1-D video tokens; and adding Gaussian noise to the video tokens to obtain the initial noisy video.

Example 14. The system of any one of Examples 1-13, the operations comprising: processing the personalization embeddings through a first cross-attention layer from the text embeddings that are processed through a second cross-attention layer; and combining outputs of the first and second cross-attention layers to condition the diffusion model.

Example 15. The system of any one of Examples 1-14, the operations comprising: evaluating the generated personalized video using a subject similarity metric that measures similarity between reference images and segmented subjects in the generated personalized video; and evaluating the generated personalized video using a dynamic degree metric that measures optical flow magnitude between consecutive generated video frames.

Example 16. The system of Example 15, the operations comprising: segmenting subjects from the generated personalized video; segmenting the subjects from a ground truth video; and computing the subject similarity metric by measuring average cosine similarity between the reference images and the segmented subjects of the generated video frames.

Example 17. The operations of any one of Examples 15-16, the operations comprising: detecting faces in the generated personalized video using a face detection algorithm; detecting faces in a ground truth video using the same face detection algorithm; and computing a face similarity metric by measuring average cosine similarity between reference face crops and generated face crops.

Example 18. The operations of any one of Examples 15-17, the operations comprising: computing a text similarity metric by measuring cosine similarity between text embeddings and the generated video frames; and computing a video similarity metric by measuring average cosine similarity between ground truth video frames and generated video frames.

Example 19. A computer-implemented method comprising: receiving a text prompt describing a video to be generated, a plurality of reference images each depicting a corresponding subject, and binding information that associates each reference image with a corresponding entity word in the text prompt; extracting features from each reference image and fusing the extracted features with text embeddings of the corresponding entity word based on the binding information to create personalization embeddings; generating an initial noisy video; and iteratively denoising the noisy video using a diffusion model conditioned on both the text prompt and the personalization embeddings to generate a personalized video that preserves identity of the corresponding subjects in the reference images while allowing for natural motion and pose variations.

Example 20. A non-transitory computer-readable storage medium storing instructions that, when executed by at least one processor, cause the at least one processor to perform operations comprising: receiving a text prompt describing a video to be generated, a plurality of reference images each depicting a corresponding subject, and binding information that associates each reference image with a corresponding entity word in the text prompt; extracting features from each reference image and fusing the extracted features with text embeddings of the corresponding entity word based on the binding information to create personalization embeddings; generating an initial noisy video; and iteratively denoising the noisy video using a diffusion model conditioned on both the text prompt and the personalization embeddings to generate a personalized video that preserves identity of the corresponding subjects in the reference images while allowing for natural motion and pose variations.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” and “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
receiving a text prompt describing a video to be generated, a plurality of reference images each depicting a corresponding subject, and binding information that associates each reference image with a corresponding entity word in the text prompt;
extracting features from each reference image and fusing the extracted features with text embeddings of the corresponding entity word based on the binding information to create personalization embeddings;
generating an initial noisy video; and
iteratively denoising the noisy video using a diffusion model conditioned on both the text prompt and the personalization embeddings to generate a personalized video that preserves identity of the corresponding subjects in the reference images while allowing for natural motion and pose variations.

2. The system of claim 1, wherein the diffusion model comprises multiple cross-attention layers and a self-attention layer.

3. The system of claim 2, the operations comprising:
encoding each of the plurality of reference images into image tokens;
projecting fused embeddings of each reference image and its corresponding entity word;
applying a residual connection with the image tokens for each reference image;
adding a learnable image index embedding to separate tokens from different reference images, wherein tokens from the same reference image share the same image index embedding; and
concatenating the personalization embeddings from all reference images to create a combined personalization embedding for conditioning the diffusion model.

4. The system of claim 3, the operations comprising:
processing the combined personalization embedding by a first cross-attention layer of the multiple cross-attention layers; and
processing the text embeddings by a second cross-attention layer of the multiple cross-attention layers.

5. The system of claim 1, the operations comprising:
applying data augmentation to the reference images before extracting the features to prevent the diffusion model from overfitting to unintended properties of the reference images.

6. The system of claim 1, the operations comprising:
encoding the initial noisy video into a set of video tokens using a video encoder; and
decoding a de-noised set of video tokens back into a video using a video decoder.

7. The system of claim 1, wherein the diffusion model is trained to perform a set of training operations comprising:
accessing a plurality of training data, the plurality of training data comprising a plurality of videos depicting multiple subjects and corresponding captions associated with the plurality of videos;
selecting an individual video from the plurality of training data along with an individual caption of the corresponding captions associated with the individual video;
retrieving entity words from the individual caption using a large language model (LLM), wherein the entity words include subject entities and background entities;
selecting multiple frames from the individual video;
extracting individual images for individual subjects and a background from the selected multiple frames;
binding each extracted individual image with its corresponding entity word in the individual caption to create a training personalization embedding;
generating a training video using the diffusion model conditioned on both the individual caption and the training personalization embedding;
computing a deviation between the training video and the selected individual video; and
updating parameters of self-attention layers and cross-attention layers of the diffusion model based on the computed deviation.

8. The system of claim 7, wherein updating the parameters comprises:
applying a gradient descent optimization algorithm to minimize the deviation; and
applying gradient clipping with a predetermined value to ensure stable training.

9. The system of claim 7, the set of training operations comprising:
creating clean background images as a portion of the extracted individual images by removing the subjects depicted in the selected multiple frames and applying inpainting; and
applying data augmentation to the extracted individual images to prevent overfitting to unintended properties.

10. The system of claim 9, the operations for applying data augmentation comprising:
downscaling and applying Gaussian blurring to the extracted individual images to prevent overfitting to image resolution; and
applying color jittering and brightness adjustment to mitigate overfitting on lighting conditions.

11. The system of claim 9, the operations for applying data augmentation comprising:
applying horizontal flip, image shearing, and rotation to the extracted individual images to weaken overfitting on the subject's pose; and
applying random cropping to the extracted individual images to increase diversity during training.

12. The system of claim 9, wherein computing the deviation comprises:
encoding the individual video into video tokens; and
comparing the encoded individual video tokens with denoised video tokens of the training video generated by the diffusion model.

13. The system of claim 1, the operations comprising:
tokenizing the video into a sequence of 1-D video tokens; and
adding Gaussian noise to the video tokens to obtain the initial noisy video.

14. The system of claim 1, the operations comprising:
processing the personalization embeddings through a first cross-attention layer from the text embeddings that are processed through a second cross-attention layer; and
combining outputs of the first and second cross-attention layers to condition the diffusion model.

15. The system of claim 1, the operations comprising:
evaluating the generated personalized video using a subject similarity metric that measures similarity between reference images and segmented subjects in the generated personalized video; and
evaluating the generated personalized video using a dynamic degree metric that measures optical flow magnitude between consecutive generated video frames.

16. The system of claim 15, the operations comprising:
segmenting subjects from the generated personalized video;
segmenting the subjects from a ground truth video; and
computing the subject similarity metric by measuring average cosine similarity between the reference images and the segmented subjects of the generated video frames.

17. The operations of claim 15, the operations comprising:
detecting faces in the generated personalized video using a face detection algorithm;
detecting faces in a ground truth video using the same face detection algorithm; and
computing a face similarity metric by measuring average cosine similarity between reference face crops and generated face crops.

18. The operations of claim 15, the operations comprising:
computing a text similarity metric by measuring cosine similarity between text embeddings and the generated video frames; and
computing a video similarity metric by measuring average cosine similarity between ground truth video frames and generated video frames.

19. A computer-implemented method comprising:
receiving a text prompt describing a video to be generated, a plurality of reference images each depicting a corresponding subject, and binding information that associates each reference image with a corresponding entity word in the text prompt;
extracting features from each reference image and fusing the extracted features with text embeddings of the corresponding entity word based on the binding information to create personalization embeddings;
generating an initial noisy video; and
iteratively denoising the noisy video using a diffusion model conditioned on both the text prompt and the personalization embeddings to generate a personalized video that preserves identity of the corresponding subjects in the reference images while allowing for natural motion and pose variations.

20. A non-transitory computer-readable storage medium storing instructions that, when executed by at least one processor, cause the at least one processor to perform operations comprising:
receiving a text prompt describing a video to be generated, a plurality of reference images each depicting a corresponding subject, and binding information that associates each reference image with a corresponding entity word in the text prompt;
extracting features from each reference image and fusing the extracted features with text embeddings of the corresponding entity word based on the binding information to create personalization embeddings;
generating an initial noisy video; and
iteratively denoising the noisy video using a diffusion model conditioned on both the text prompt and the personalization embeddings to generate a personalized video that preserves identity of the corresponding subjects in the reference images while allowing for natural motion and pose variations.
